(19) United States
(12) Patent Application Publication
(10) Pub. No.: US 2021/0260732 A1
(43) Pub. Date: Aug. 26, 2021

(54) SIX BIT WRISTDRIVER

(71) Applicants: Donald Jess MCILRATH, Glendale, AZ (US); Patricia Dianne MCILRATH, Glendale, AZ (US)

(72) Inventors: Donald Jess MCILRATH, Glendale, AZ (US); Patricia Dianne MCILRATH, Glendale, AZ (US)

(21) Appl. No.: 16/884,699

(22) Filed: May 27, 2020

Related U.S. Application Data
(60) Provisional application No. 62/995,973, filed on Feb. 24, 2020.

(51) Int. Cl. B25B 15/02; B25B 23/16; B25B 23/00; B25G 1/08

(52) U.S. Cl. CPC B25B 15/02; B25G 1/085; B25B 23/0021; B25B 23/16

(57) ABSTRACT

The Six Bit WristDriver was created for the person who wants a more efficient tool not available anywhere else. The Six Bit WristDriver makes your work easier, faster, it's a pleasure to use. It's a new type of screwdriver, one with 6 different bits, easy and fast to change. The short shaft is on purpose, extensions can be added. Replacing bits are a snap, pull the old bit out of the shaft, select one of the five bits (your choice) on the handle, press down on the end of the one you want, the opposite end pops up. Pull it off and replace with the one you were using. Place the WristDriver in your hand and rotate the wrist only (not forearm) notice how the bit centers in the screw slot. The “S” angle can be used to tighten or loosen the fastener. The blade is electrically isolated from the bits on the handle.

Made for people who take their work seriously. With hundreds of screwdriver bits in use there's only one handheld screwdriver that can handle them efficiently, the Six Bit WristDriver, the wrist rotates, and the arm stays still, the correct built-in angle causes the blade to turn without wobbling in the screw head. Designed for righties and lefties. Designed so the center of thrust is always on the screw head. The shaft is bent at the handle (riding on a ball bearing) for those jobs where extra torque is necessary. Need another type of bit, there's one of six favorites right there in your hand, on the handle of the Six Bit WristDriver. The Six Bit “WristDriver” can Insert more leverage when trying to loosen or tighten screws or nuts, the “S” angle helps to even drill holes in wood, aluminum and sheet metal for small screws with Hex drill bits. The Six Bit “WristDriver” can be used short or with a longer extension tool. The “S” angle keeps the bit centered in the screw. To remove a bit from the handle just press on the top of the bit, the bottom pops up to be removed and the last used bit inserted. The angles of the shaft are all important, the shaft must rotate from the driver bit to the middle the wrist, where it connects to the hand. If the angle is correct the shaft will rotate, if not correct the shaft will wobble—not good in the screw slot.

The blade is also electrically isolated from the bits in the handle.

### Materials

### B/T=Brass Tube S/T=Stainless Steel Tube

A 4 pieces,

A1: 1 Hardwood Dowel ¼″ dia.×2¼″ long,

A2: 1 B/T ½″ long× 9/32″ dia.

A3: 1 B/T ½″ long× 5/16″ dia.

A4: 1 S/T ¾″ Long× 23/64″ dia.

B 1 piece, dowel 9/16″ long ½″ dia. with 17/64″ hole
C 3 pieces,

C1: 1 B/T 9/32″ dia.×⅜″ long,

C2: 1 B/T 5/16″ dia.×⅜″ long,

C3: 1-S/T ½″ dia.×⅜″ long.

D 1 piece, dowel 1 1/16 long×½″ wide with 17/64″ hole halfway through the center
E 1 piece, Wood electrical isolation sleeve
F 1 piece, ⅜″ Ball bearing
G 1 piece, Crank mushroomed end and exposed end
H a1 piece, Crank sleeve 1.25″ long× 5/16″ steel tube
J 5 pieces, accessory clips
K Slot for Crank assembly

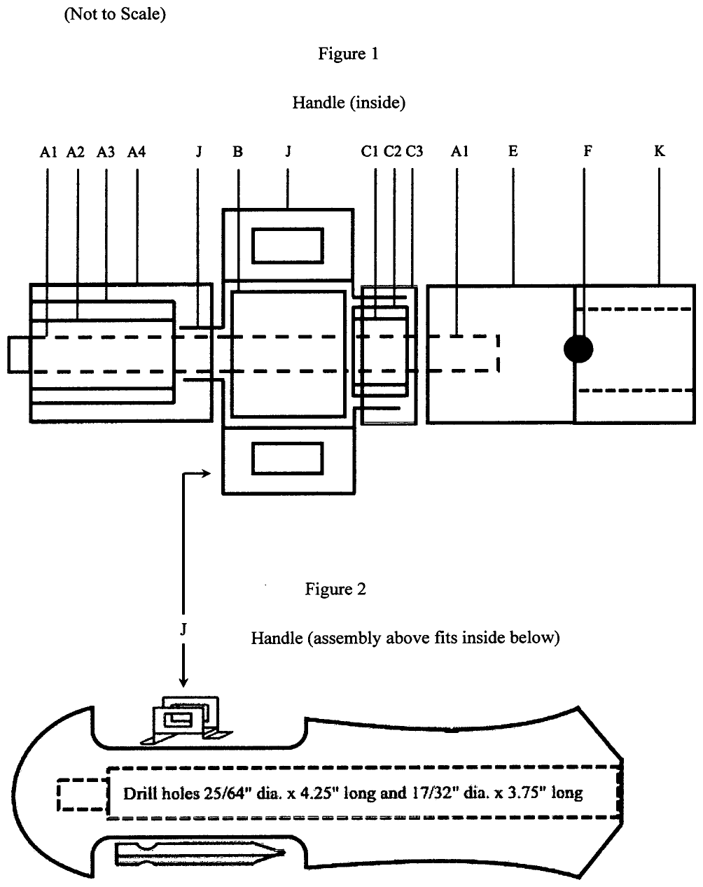

### Refer to FIG. 1

FIG. 1 The layout inside the handle shows the assembly of the parts that hold the bit clips in place, the swivel action for the WristDriver blade and the uniqueness of this tool.

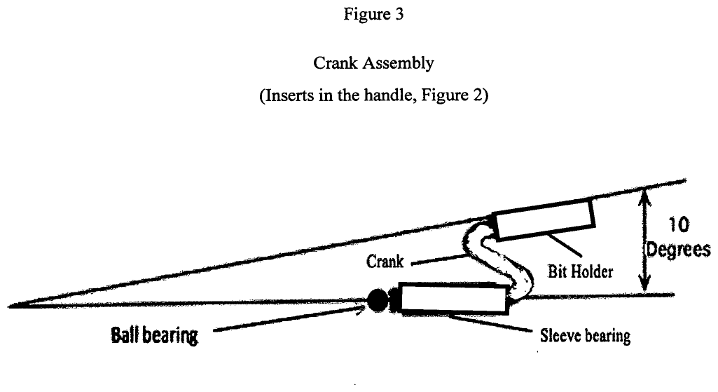

FIG. 2 An outside view and cross section of the handle.

FIG. 3 The crankshaft fits inside the open end of the WristDriver which is held in place by the bearing sleeve, epoxy and expanded end of the shaft outside the sleeve bearing.

1. I claim the Six Bit WristDriver is the only tool of its kind that will be on the market which has the “S” curve in the blade, which is used for centering the shaft in the screw and rotating the driver.
